(19) United States
(12) Patent Application Publication
(10) Pub. No.: US 2026/0087841 A1
(43) Pub. Date: Mar. 26, 2026

(54) ENHANCED ASSISTANT FOR SUGGESTIONS FOR MATH THAT IS HANDWRITTEN ON A COMPUTER DEVICE

(71) Applicants: Kwan Yau Leo LAU, Hong Kong (CN); Tin Hang Hugo CHU, London (GB); Trung Tan NGO, Ho Chi Minh City (VN); Radu Calin CALIN, Cluj-Napoca (RO); Mimansha GUPTA, London (GB); Igor ILIC, Belgrade (RS); Novak NOVAKOVIC, Belgrade (RS)

(72) Inventors: Kwan Yau Leo LAU, Hong Kong (CN); Tin Hang Hugo CHU, London (GB); Trung Tan NGO, Ho Chi Minh City (VN); Radu Calin CALIN, Cluj-Napoca (RO); Mimansha GUPTA, London (GB); Igor ILIC, Belgrade (RS); Novak NOVAKOVIC, Belgrade (RS)

(21) Appl. No.: 19/332,984

(22) Filed: Sep. 18, 2025

(30) Foreign Application Priority Data
Sep. 23, 2024 (WO) PCT/CN2024/120265

(51) Int. Cl. G06V 30/32; G06V 10/764; G06V 10/94; G06V 30/19; G06V 30/22; G06V 30/30

(52) U.S. Cl. CPC G06V 30/387; G06V 10/764; G06V 10/945; G06V 30/19173; G06V 30/22; G06V 30/30; G06V 30/347

(57) ABSTRACT

This disclosure describes systems, methods, and devices for analyzing and providing suggestions for handwritten math characters entered on a device. A method may include receiving first handwritten strokes digitally entered on the device by a user; inputting the first handwritten strokes into a machine learning model; classifying, by the machine learning model, the first handwritten strokes as first mathematical characters; causing the device to present, based on the classifying, a selectable indication of the first handwritten strokes; receiving a first user selection of the selectable indication; causing the device to present, based on the first user selection, one or more selectable suggestions for second mathematical characters to follow the first mathematical characters; receiving a second user selection of a first suggestion of the one or more selectable suggestions; causing the device to present, based on the second user selection, synthesized second handwritten strokes representing the second mathematical characters.

### CROSS-REFERENCE TO RELATED APPLICATION(S)

This application claims the benefit of PCT Provisional Application No. PCT/CN2024/120265, filed Sep. 23, 2024, the disclosure of which is incorporated herein by reference as if set forth in full.

### TECHNICAL FIELD

Embodiments of the present invention generally relate to systems and methods for analyzing and providing suggestions for math handwritten on a computer device.

### BACKGROUND

Devices may allow users to handwrite text rather than enter text using keystrokes. Handwritten text on a computer device presents challenges in identifying the characters of the handwritten text that are not present when converting keystrokes to characters.

### BRIEF DESCRIPTION OF THE DRAWINGS

FIG. 1 illustrates an example of math that is handwritten on a computer device and emphasized for possible suggestions, in accordance with one embodiment.

FIG. 2 shows example selectable indications providing mathematical interpretations of digitally handwritten strokes and suggestions for next mathematical steps, in accordance with one embodiment.

FIG. 3 shows an example workflow for the math assistant of FIG. 1, in accordance with one embodiment.

FIG. 4 is an example schematic diagram of one or more artificial intelligence models that may be used for an enhanced assistant for math that is handwritten on a computer device, in accordance with one embodiment.

FIG. 5 is an example system for an enhanced assistant and suggestions for math that is handwritten using a device, in accordance with one embodiment.

FIG. 6 illustrates an example neural network, in accordance with one embodiment.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Aspects of the present disclosure involve systems, methods, and the like, for analyzing and providing suggestions for math handwritten on a computer device.

Devices may allow users to input characters in a variety of ways, such as with keystrokes and with stylus strokes. When a user enters a keystroke (e.g., using a keyboard), the keystroke is converted to a corresponding character, such as a letter, number, symbol, or punctuation mark. When a key is pressed on a keyboard, it is converted into a binary number that represents a character, so there is no ambiguity in determining which character a user typed with a keystroke. In contrast, when a user handwrites text into a device, such as with a stylus or their finger, there are many variations in the handwriting that introduce ambiguity when determining what characters the handwriting represents.

Analyzing characters handwritten into a device, therefore, depends on the ability of the device to correctly identify the characters represented by the handwriting. Humans may identify and categorize handwritten characters after seeing only a few examples, but a machine's ability to identify and categorize handwritten characters may require significantly more examples to train. An electronic device encompasses a broad array of electronic gadgets, including tools such as a digital stylus or any comparable apparatus, which permit the user to sketch characters on a computer interface as a form of hand-drawn or handwritten input. Beyond the use of an electronic device for inputting strokes onto the computer device, users can also engage the intuitiveness of their own fingers as a dynamic and natural means to accomplish the same task, thus providing a more direct and tactile interaction with the digital interface.

Throughout this disclosure, while electronic devices are primarily illustrated as examples, it should be understood that the scope of interaction is not limited to these alone. A user's finger also serves as a viable tool for interacting with computer devices. Hence, the exemplification of an electronic device should not be misconstrued as a limitation, but rather, it serves as one among many possible methods for interaction in the broader digital landscape. A computer device, such as a laptop, tablet, or smartphone, can be described as a sophisticated system equipped with an interactive interface designed to accept and interpret strokes from an electronic device, recording these inputs as lines, characters, shapes, and more. This interaction transforms abstract human action into digitized elements.

To allow a computer device to analyze math input by characters handwritten into the computer device, correctly identifying the handwritten text is important to the computer device's ability to assess the math represented by the handwritten text. If the computer device improperly identifies handwritten math, then the computer device may not correctly assess whether the math is correct, identify what type of math is handwritten, and provide proactive suggestions to help complete the math.

Typing complex math equations and expressions often requires external tools like calculators, specialized applications or knowledge of mathematical languages like LaTeX. Manually inputting symbols and expressions slows down the problem-solving and thinking process making typed math tedious, with a high likelihood of making mistakes, such as misplacing symbols or miscalculating figures.

In contrast, performing calculations directly from written math is faster and more intuitive. Writing math by hand allows for immediate adjustments and more efficient thinking, and makes it even quicker to reach solutions.

In addition, when solving complex math problems, an end-user can often get stuck determining the best possible next step, such as what available options do they have when determining the solving strategy, for example, when to expand an expression or simplify it and more. This hesitation slows down the solving process and even impacts the confidence in math ability of the user.

There is therefore a need for enhanced device-based assistance and suggestions for math that is handwritten on a computer device.

In one or more embodiments, a computer device may receive handwritten strokes on a screen or touchpad, such as with a stylus or a user's finger, representing handwritten characters. The device may analyze the handwritten strokes to identify the characters represented by the handwritten strokes based on the X and Y coordinates of the strokes on the computer device. The computer device may recognize math represented by the characters, strip units from the math (e.g., X apples and Y oranges as handwritten inputs may be stripped to X and Y without the units - apples and oranges).

The present disclosure offers smart real-time assistance for solving or suggesting the best possible next step for math problems to a device end-user. The end-user may handwrite a line of math (e.g., on a computer device) followed by an equal sign, and the device may highlight or otherwise emphasize the line when valid solutions or suggestions are available. By analyzing the structure and type of problem from the line or related lines of handwritten math, the present disclosure offers contextually relevant suggestions that range from simple arithmetic solving to solving systems of equations, trigonometry, calculus and other math topics.

When to trigger the presentation of math suggestions may be based on a confidence score in a handwriting recognition artificial intelligence (AI) tool and math and symbol detection algorithms. If both are confident in recognizing the math line, and a math suggestions algorithm detects a possible next step or solution, math assistance will be triggered to show the relevant options (e.g., suggestions for continuing/completing the math problem).

End-users can tap on one of the displayed suggestions (e. g,. presented on a computer device) and see it generated in a handwriting style. In this manner, when a user selects a suggestion to be included in the math solution, the suggestion may be synthesized to the user's handwriting (e.g., based on characteristics of the handwriting) so that it appears consistent with the user's handwriting in other parts of the math solution.

End-users can also deactivate the math suggestion feature if they want to solve the problem themselves or minimize distractions.

End-user can also choose to edit the LaTeX (e.g., math typesetting) interpretation of the handwritten math line using a keyboard, and the math line may be regenerated with the changes in handwriting.

End-users can copy expression, change solving strategy, or remove the math suggestion altogether.

End-users can edit the line of math, or relevant lines of math in determining the solution or suggestion, and the generated math may be updated to display the new suggestion.

One goal of the present disclosure is to enhance the end-user's workflow by offering math assistance at crucial decision points in problem-solving. Whether solving basic arithmetic and algebra, or tackling complex trigonometric or calculus problems, the enhanced math assistance techniques ensure that an end-user can efficiently progress through their work with increased confidence.

By combining the natural fluidity of handwriting with intelligent math recognition and suggestion, the math assistance techniques herein will be a core differentiating factor from other note-taking techniques.

The enhanced techniques herein provide a technical solution to the problem of real-time mathematical guidance in a digital handwriting environment. Unlike existing tools that focus solely on recognizing math symbols or converting handwritten equations into text, the enhanced techniques herein uniquely combine advanced handwriting recognition with intelligent contextual suggestions for the next mathematical step. This system not only identifies equations, but also provides tailored solutions or hints, such as applying the correct algebraic method or trigonometric identity, based on the specific type of problem the user is solving. The integration of real-time assistance within a handwritten interface, coupled with dynamic, context-aware suggestions for solving complex equations, represents a technical innovation that addresses a clear need in digital math tools.

The enhanced techniques herein may apply a multi-step approach to recognize, suggest and synthesize the math suggestion for the end-user.

### Step 1: Detection & Recognition

Because a user can write both math and non-math lines on a digital page, the first step is to recognize a line from the end-user's input and apply a classification of math or non-math line. If the input is classified as math, a math handwriting recognition system may determine the validity of the math line, detecting all the numbers, variables and symbols used in the math line.

The line is then highlighted to users with a glowing effect and made tappable.

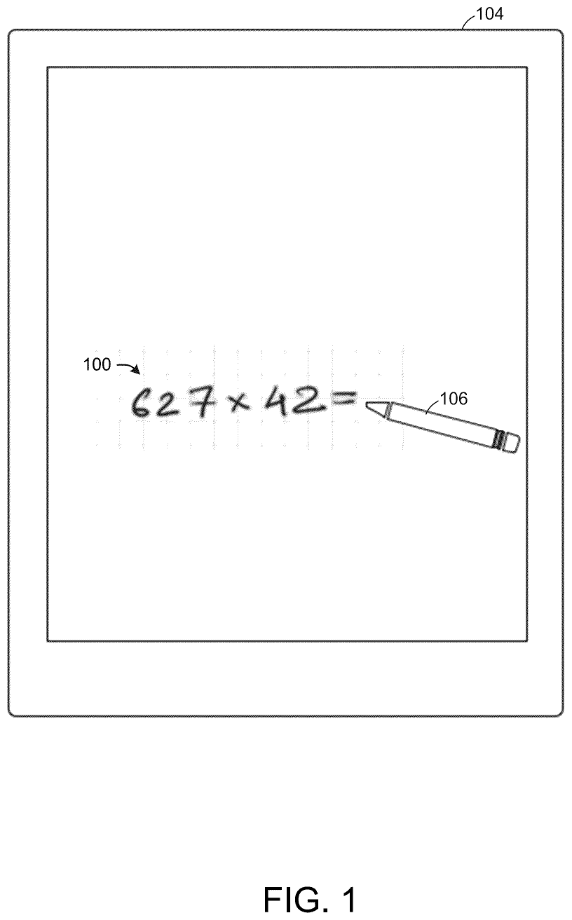

FIG. 1 illustrates an example of math that is handwritten on a computer device and emphasized for possible suggestions, in accordance with one embodiment.

In the example shown in FIG. 1, handwritten strokes 102 are “627×42=” on one line. The handwritten strokes 102 are entered on a device 104 using a stylus 106 or another handwriting instrument.

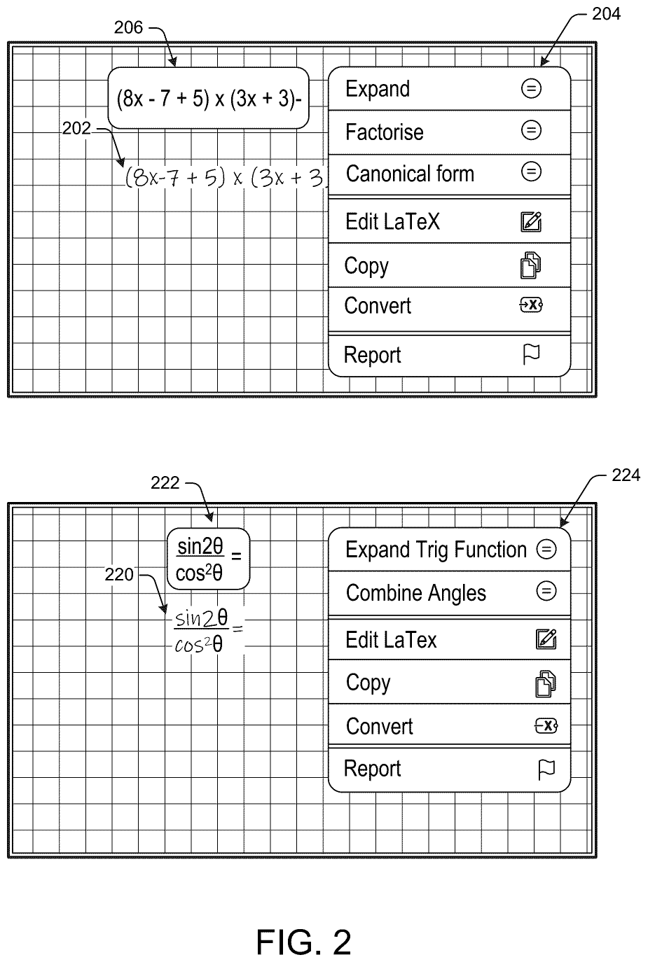

The line of handwritten strokes 102 may be recognized as math, and highlighted or otherwise emphasized (e.g., as shown in FIG. 2) to signal to the user that the line is selectable. When the user selects the emphasized line, a best possible next step may be presented as a selectable option for the user based on the math that is recognized from the handwriting.

A math suggestion engine may determine the best possible next step based on the recognized math from the handwritten strokes 102. The end-user may be presented with one or more different options from which to select for auto-entry into the handwritten math solution. For example, if the input is a math expression, the end-user can choose to factorize, expand or convert to canonical form. For trigonometric problems, the user can simplify the expression in many ways like combining angles, trigonometric simplification, and the like.

FIG. 2 shows example selectable indications providing mathematical interpretations of digitally handwritten strokes and suggestions for next mathematical steps.

One example in FIG. 2 shows digitally handwritten strokes 202 “(8x−7+5)×(3x+3)” recognized as math characters and interpreted as (8x−7+5)×(3x+3) (e.g., as shown in a pop-up menu of suggestions 204 that may be presented upon selection of the math characters when they are emphasized). A user may edit the interpretation 206 of the handwritten strokes 202 and cause an update to the suggestions 204 based on the update. The suggestions 204 for the math characters, as interpreted, may represent a next (e.g., consecutive) subsequent step, such as expanding, factorizing, or presenting in canonical form, any of which the user may select to cause a synthesized presentation of the next math step in digital handwriting that mimics the user's handwriting.

Another example in FIG. 2 shows digitally handwritten strokes 220 representing a trigonometric equation of “sin(2*theta)/cos2(theta)” recognized as math characters and interpreted 222 as sin(2*theta)/cos2(theta) (e.g., as shown in a pop-up menu of suggestions 224 that may be presented upon selection of the math characters when they are emphasized). A user may edit the interpretation 222 and cause an update to the suggestions 224 based on the update. The suggestions 224 for the math characters, as interpreted, may represent a next (e.g., consecutive) subsequent step, such as expanding the trigonometric function or combining angles, any of which the user may select to cause a synthesized presentation of the next math step in digital handwriting that mimics the user's handwriting.

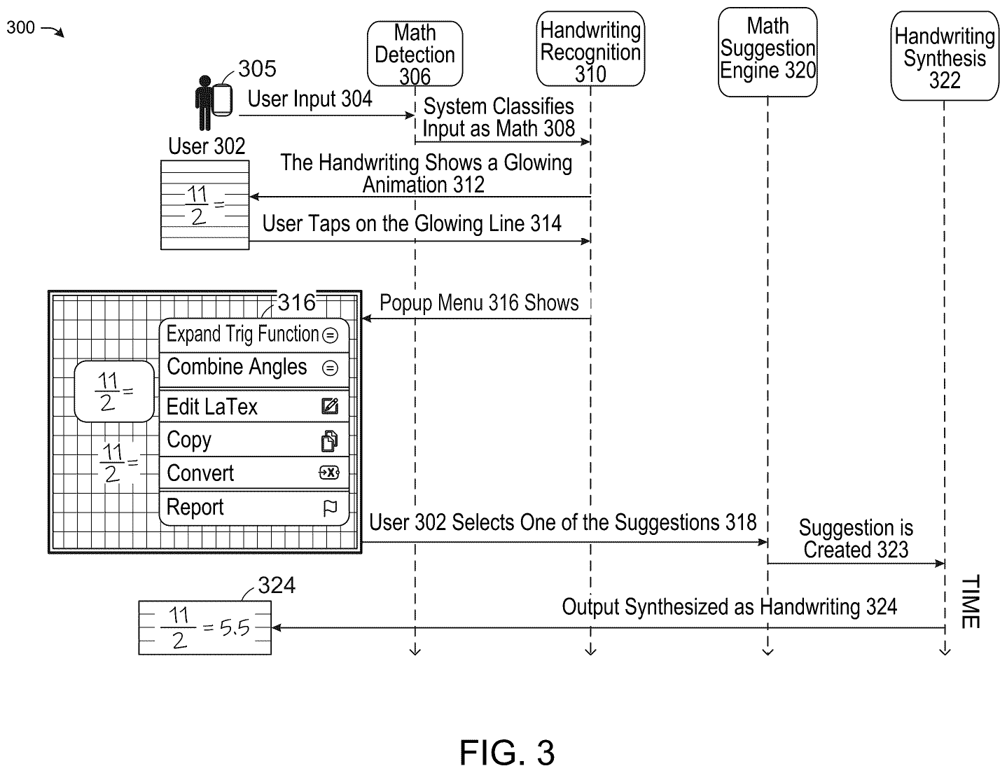

FIG. 3 shows an example workflow 300 for the math assistant of FIG. 1.

A user 302 may provide a user input 304 to a device 305 in the form of handwritten strokes. Handwriting recognition models of a math detection system 306, whether operating locally on the device 305 or remote from the device 305, may analyze and classify the handwriting input as math 308. A handwriting recognition system 310 may identify the characters of the user input 304 (e.g., the interpretation of the handwritten strokes). The device 305 then may show a glowing animation or other emphasis of the handwritten strokes on the device 305 to signal to the user 302 that math suggestions are available. When the user 302 taps on the glowing line of the handwriting or otherwise selects the emphasized interpretation of the math via the device 305, a popup menu 316 of math suggestions is presented via the device 305. When the user 302 selects 318 one of the suggestions from the popup menu 316, a math suggestion engine 320, whether operating locally on the device 305 or remote from the device 305, may identify and create 323 one or more math suggestions as the next best steps to enter in the math solution. A handwriting synthesis engine 322, whether operating locally on the device 305 or remote from the device 305, may synthesize the suggestion(s) to appear via the device 305 consistent with the user's handwriting, and may provide the synthesized handwriting 324 to the device 305 for presentation.

When the user 302 selects a suggestion from the popup menu 316 for auto-completion, the device 305 may synthesize the characters of the suggested characters to include handwriting features in terms of user's hand writing style, and the features of the device 305 (e.g., stylus pen tool or otherwise) that the user 302 has chosen for the particular handwriting. For example, the thickness, texture, color, etc. of the strokes (e.g., for handwriting synthesis) may be considered as features used to synthesize the handwriting of characters presented when selected for auto-completion.

In one or more embodiments, the handwriting synthesis modules 322 may use AI/ML, such as deep learning, with a large dataset to train one or more models to output characters based on similarities and differences between features of handwritten characters. For example, the training data may include many versions of characters handwritten individually and in combination with other letters. One or more AI/ML models may be trained to identify the similarities and differences between like characters and combinations of characters so that when the user's actual handwritten strokes are input to the one or more models, the one or more models may recognize the features of the handwritten strokes and mimic the features when generating the suggestion for auto-completion.

In one or more embodiments, the handwriting recognition system 310 may determine a confidence level in the recognized handwritten characters. If the confidence score of the recognized text exceeds a confidence threshold for representing certain characters, such may indicate that the recognized text is likely to represent a particular identified set of characters. If the confidence score of the recognized text exceeds another confidence threshold for representing a particular mathematical expression, such may indicate that the recognized text is likely to represent the mathematical expression.

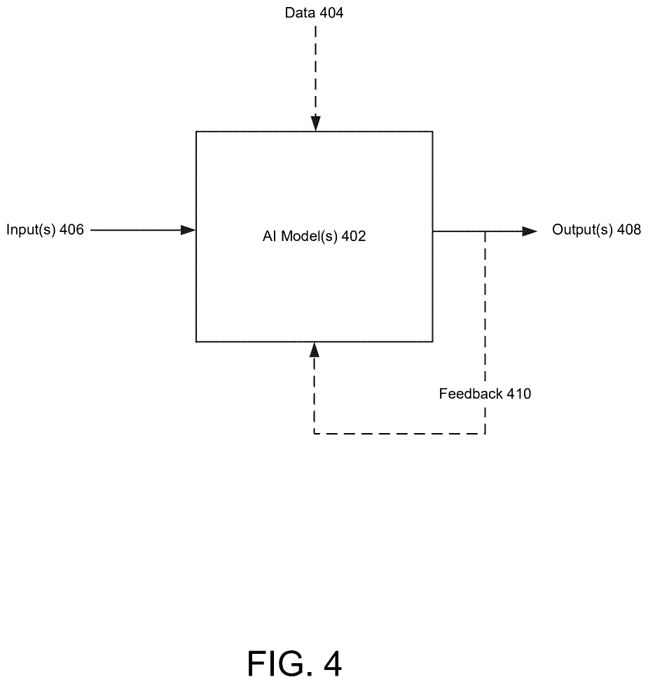

FIG. 4 is an example schematic diagram of one or more artificial intelligence models that may be used for an enhanced assistant for math that is handwritten on a computer device, in accordance with one embodiment.

Referring to FIG. 4, one or more artificial intelligence (AI) models 402 (or machine learning models) may be used for any of detecting the handwritten characters, determining that the handwritten characters represent math, identifying steps/lines in the math, unit stripping, and/or identifying errors in the math. The one or more AI models 402 may receive inputs, optionally may receive data 404 (e.g., training data, one-or few-shot examples, user feedback, etc.), and may generate outputs 408. Optionally, feedback 410 from the outputs 408 may be input into the one or more AI models 402, such as human-in-the-loop feedback, user feedback, comparisons of the outputs 408 to known outputs and their differences (e.g., used to adjust the one or more AI models 402, such as by adjusting weights for identifying characters, math steps, etc.).

In one or more embodiments, the text identification of handwritten characters may use few-shot learning, one-shot learning, or no-shot learning. In few-shot learning, computer vision and/or natural language processing may be used to recognize, parse, and classify handwritten characters. In one-shot learning, images of handwritten text may be used to identify similarities on the example images and the handwritten text inputs. In zero-shot learning, a machine learning model may not need to be trained, but instead learns the ability to detect and classify handwritten characters as math or non-math.

In one or more embodiments, when the one or more AI models 402 are used to detect handwritten characters, the inputs 406 may be the handwritten strokes and/or characteristics of the handwritten strokes, such as their pixel coordinates on the display with which they were input. The data 404 may include features of characters, such as their coordinates, shapes, sizes, and the like, accounting for different fonts, such as cursive, block letters, etc. The outputs 408 may include the characters identified from the handwritten strokes. The outputs 408 may be re-input to the one or more AI models 402 until the one or more AI models 402 determine that the confidence score assigned to the identified characters exceeds a threshold confidence. The closer the similarities between the inputs 406 and the known characters, for example, the higher the confidence score for identifying the characters.

In one or more embodiments, when the one or more AI models 402 are used for math recognition, the inputs 406 may include the identified characters from the handwritten strokes. The data 404 may include mathematical characters and non-mathematical characters (e.g., for distinguishing between math and other handwritten characters). The outputs 408 may include one or more files indicating that the characters represent math, where steps/lines begin and end, where an answer begins and ends, and the like.

In one or more embodiments, when the one or more AI models 402 are used for unit stripping, the inputs 406 may include the mathematical characters and/or one or more files indicating that the characters represent math, where steps/lines begin and end, where an answer begins and ends, and the like. The data 404 may include variables, constants, and/or units (e.g., to distinguish between units and non-units in the math). The outputs 408 may include unit-stripped math characters.

In one or more embodiments, when the one or more AI models 402 are used for checking the math for errors, the inputs may include the unit-stripped math, which may include the one or more files indicating that the characters represent math, where steps/lines begin and end, where an answer begins and ends, and the like, with the units removed from the numbers/variables in the math. The data 404 may include previous lines/steps of the math answer provided based on the handwritten strokes, and/or data showing similarities and differences between mathematical structures and/or numerical equivalence. The outputs 408 may include an indication of any suggestions identified (e.g., FIGS. 2 and 3).

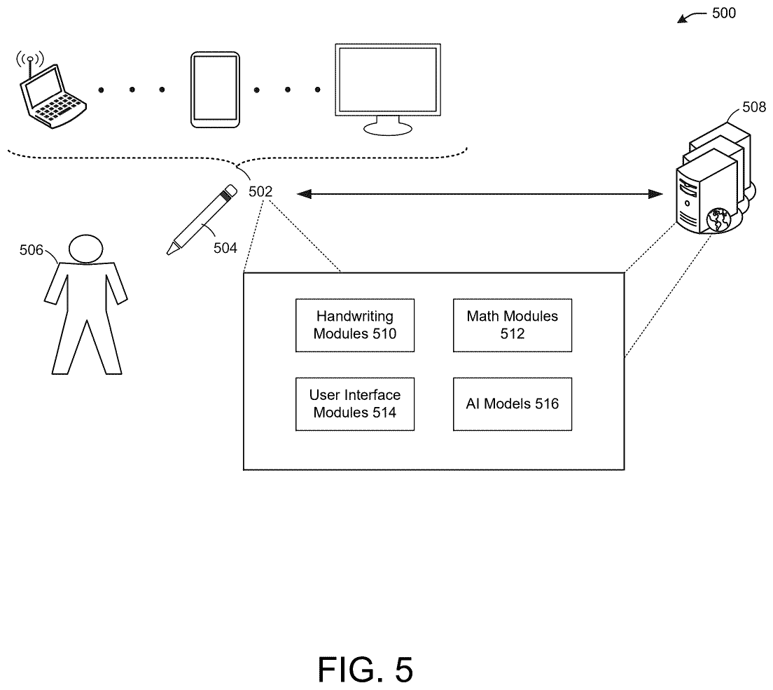

FIG. 5 is an example system 500 for an enhanced assistant and suggestions for math that is handwritten using a device, in accordance with one embodiment.

Referring to FIG. 5, the system 500 may include one or more devices 502 (e.g., laptops, desktops, smartphones, smart home assistants, wearable devices, televisions, or the like) capable of displaying text and receiving handwritten strokes (e.g., from a stylus 504, a finger of a user 506, or another input device). The system 500 may include one or more remote devices 508 (e.g., servers, cloud-based devices, etc.). The one or more devices 502 and/or the one or more remote devices 508 may execute applications that receive, analyze, and correct handwritten strokes input via the one or more devices 502. For example, the one or more devices 502 may transmit indications of the handwritten strokes and/or any analysis of the handwritten strokes to the one or more remote devices 508 (e.g., a front-end/back-end integration of the application). Alternatively, the one or more devices 502 may analyze, detect errors, and correct the handwritten text locally.

Still referring to FIG. 5, the one or more devices 502 and/or the one or more remote devices 508 may include handwriting modules 510 (e.g., for receiving and detecting handwritten strokes, identifying the characters of the handwritten strokes), math modules 512 (e.g., for detecting math in the identified characters, such as the math suggestion engine of FIG. 3, and optionally including the handwriting synthesis modules of FIG. 3), one or more user interface modules 512 (e.g., for generating the presentable data of the user interfaces shown in the figures, including the handwritten strokes, suggestions, emphasis, etc.), and AI models 516 (e.g., the one or more AI models 402 of FIG. 4).

In one or more embodiments, the one or more devices 502 may receive handwritten strokes on a screen or touchpad, such as with the stylus 504 or a user's finger, representing handwritten characters. The handwriting modules 510 may analyze the handwritten strokes to identify the characters represented by the handwritten strokes based on the X and Y coordinates of the strokes on the one or more devices 502. The handwriting modules 510 and/or the math modules 512 may recognize math represented by the characters, strip units from the math (e.g., X apples and Y oranges as handwritten inputs may be stripped to X and Y without the units - apples and oranges). When the math modules 512 detect math in the characters, the user interface modules 514 may generate and present an emphasis of the math to signal to the user one or more options for user-selectable suggestions to auto-enter in the math. The analysis and emphasis may occur in real-time so that the one or more devices 502 may notify the user of suggestions prior to completing their final answer to a mathematical question. In this manner, the enhanced techniques herein differ from the way that a human operator, such as a teacher or other human instructor, would analyze mathematical answers.

In one or more embodiments, the one or more devices 502 and/or the one or more remote devices 508 may use machine learning (e.g., the AI models 516) for one or multiple aspects of the mathematical analysis and correction. For example, a machine learning model may be used to assess the handwritten strokes as inputs, and identify the characters represented by the strokes based on features of the strokes, such as the X and Y coordinates of the strokes on the device. Another machine learning model may use named entity recognition (NER) to strip units from the characters. NER may be trained to identify and differentiate between entities, such as characters representing mathematical values and variables, and characters representing units. Another machine learning model may receive the unit-stripped characters represented by the handwritten strokes as inputs, and may be trained to identify whether the steps of the mathematical inputs represented by the unit-stripped characters are consistent with each other and with expected inputs representing the solution to a mathematical problem.

In one or more embodiments, the math modules 512 may identify lines/portions of the handwritten strokes corresponding to individual steps in a mathematical answer. For example, a step in the answer may span one or multiple lines. The math modules 512 may identify one or more characters that represent an individual step in the answer.

In one or more embodiments, the suggestion indication may be presented with selectable options for auto-completion.

In one or more embodiments, the handwriting recognition may estimate character height and scale until the height matches. A baseline estimation algorithm may match a baseline to surrounding text. The stylus width may be variable to support different digital writing tools (e.g., stylus with varying thickness, etc.), as a point density normalization may be applied to the stylus'handwritten characters.

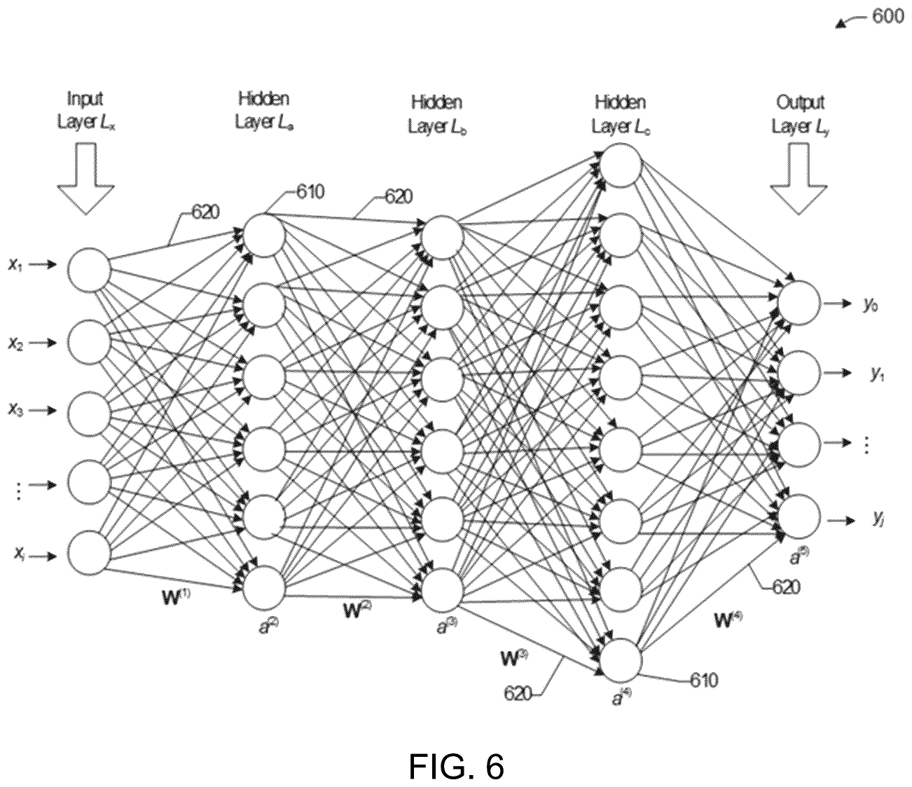

FIG. 6 illustrates an example neural network 600, in accordance with one or more embodiments.

The example neural network (NN) 600 may be implemented to identify and classify digital handwriting, identify math suggestions, and synthesize handwritten text to appear consistent with characteristics of a user's digital handwriting. The NN 600 may be deployed on the frontend user device and/or as a backend service. When deployed on the backend, the NN 600 may provide its outputs to the frontend.

The neural network (NN) 600 may be suitable for use by one or more of the computing systems (or subsystems) of the various implementations discussed herein, implemented in part by a HW accelerator, and/or the like. The NN 600 may be deep neural network (DNN) used as an artificial brain of a compute node or network of compute nodes to handle very large and complicated observation spaces. Additionally or alternatively, the NN 600 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or reinforcement (RL).

The NN 600 may encompass a variety of ML techniques where a collection of connected artificial neurons 610 that (loosely) model neurons in a biological brain that transmit signals to other neurons/nodes 610. The neurons 610 may also be referred to as nodes 610, processing elements (PEs) 610, or the like. The connections 620 (or edges 620) between the nodes 610 are (loosely) modeled on synapses of a biological brain and convey the signals between nodes 610. Note that not all neurons 610 and edges 620 are labeled in FIG. 6 for the sake of clarity.

Each neuron 610 has one or more inputs and produces an output, which can be sent to one or more other neurons 610 (the inputs and outputs may be referred to as “signals”). Inputs to the neurons 610 of the input layer L_x can be feature values of a sample of external data (e.g., input variables x_i). The input variables x_i can be set as a vector containing relevant data (e.g., observations, ML features, and the like). The inputs to hidden units 610 of the hidden layers L_a, L_b, and L_c may be based on the outputs of other neurons 610. The outputs of the final output neurons 610 of the output layer L_y (e.g., output variables y_j) include predictions, inferences, and/or accomplish a desired/configured task. The output variables y_j may be in the form of determinations, inferences, predictions, and/or assessments. Additionally or alternatively, the output variables y_j can be set as a vector containing the relevant data (e.g., determinations, inferences, predictions, assessments, and/or the like).

In the context of ML, an “ML feature” (or simply “feature”) is an individual measurable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 610 may have a threshold such that a signal is sent only if the aggregate signal crosses that threshold. A node 610 may include an activation function, which defines the output of that node 610 given an input or set of inputs. Additionally or alternatively, a node 610 may include a propagation function that computes the input to a neuron 610 from the outputs of its predecessor neurons 610 and their connections 620 as a weighted sum. A bias term can also be added to the result of the propagation function.

The NN 600 also includes connections 620, some of which provide the output of at least one neuron 610 as an input to at least another neuron 610. Each connection 620 may be assigned a weight that represents its relative importance. The weights may also be adjusted as learning proceeds. The weight increases or decreases the strength of the signal at a connection 620.

The neurons 610 can be aggregated or grouped into one or more layers L where different layers L may perform different transformations on their inputs. In FIG. 6, the NN 600 comprises an input layer L_x, one or more hidden layers L_a, L_b, and L_c, and an output layer L_y (where a, b, c, x, and y may be numbers), where each layer L comprises one or more neurons 610. Signals travel from the first layer (e.g., the input layer L_1), to the last layer (e.g., the output layer L_y), possibly after traversing the hidden layers L_a, L_b, and L_cmultiple times. In FIG. 6, the input layer L_a receives data of input variables x_i (where i=1, . . . , p, where p is a number). Hidden layers L_a, L_b, and L_c processes the inputs x_i, and eventually, output layer L_y provides output variables y_j (where j=1, . . . , p′, where p′ is a number that is the same or different than p). In the example of FIG. 6, for simplicity of illustration, there are only three hidden layers L_a, L_b, and L_c in the NN 600, however, the NN 600 may include many more (or fewer) hidden layers L_a, L_b, and L_c than are shown.

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry. ”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus includes but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived includes source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) includes: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions includes assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), and/or the like.

The term “attention” in the context of machine learning and/or neural networks, at least in some examples refers to a technique that mimics cognitive attention, which enhances important parts of a dataset where the important parts of the dataset may be determined using training data by gradient descent. The term “dot-product attention” at least in some examples refers to an attention technique that uses the dot product between vectors to determine attention. The term “multi-head attention” at least in some examples refers to an attention technique that combines several different attention mechanisms to direct the overall attention of a network or subnetwork.

The term “attention model” or “attention mechanism” at least in some examples refers to input processing techniques for neural networks that allow the neural network to focus on specific aspects of a complex input, one at a time until the entire dataset is categorized. The goal is to break down complicated tasks into smaller areas of attention that are processed sequentially. Similar to how the human mind solves a new problem by dividing it into simpler tasks and solving them one by one. The term “attention network” at least in some examples refers to an artificial neural networks used for attention in machine learning.

The term “backpropagation” at least in some examples refers to a method used in NNs to calculate a gradient that is needed in the calculation of weights to be used in the NN; “backpropagation” is shorthand for “the backward propagation of errors.” Additionally or alternatively, the term “backpropagation” at least in some examples refers to a method of calculating the gradient of neural network parameters. Additionally or alternatively, the term “backpropagation” or “back pass” at least in some examples refers to a method of traversing a neural network in reverse order, from the output to the input layer.

The term “Bayesian optimization” at least in some examples refers to a sequential design strategy for global optimization of black-box functions that does not assume any functional forms. Additionally or alternatively, the term “Bayesian optimization” at least in some examples refers to an optimization technique based upon the minimization of an expected deviation from an extremum. At least in some examples, Bayesian optimization minimizes an objective function by building a probability model based on past evaluation results of the objective.

The term “classification” in the context of machine learning at least in some examples refers to an ML technique for determining the classes to which various data points belong. Here, the term “class” or “classes” at least in some examples refers to categories, and are sometimes called “targets” or “labels.” Classification is used when the outputs are restricted to a limited set of quantifiable properties. Classification algorithms may describe an individual (data) instance whose category is to be predicted using a feature vector. As an example, when the instance includes a collection (corpus) of text, each feature in a feature vector may be the frequency that specific words appear in the corpus of text. In ML classification, labels are assigned to instances, and models are trained to correctly predict the pre-assigned labels of from the training examples. ML algorithms for classification may be referred to as a “classifier.” Examples of classifiers include linear classifiers, k-nearest neighbor (kNN), decision trees, random forests, support vector machines (SVMs), Bayesian classifiers, convolutional neural networks (CNNs), among many others (note that some of these algorithms can be used for other ML tasks as well).

The term “computational graph” at least in some examples refers to a data structure that describes how an output is produced from one or more inputs.

The term “converge” or “convergence” at least in some examples refers to the stable point found at the end of a sequence of solutions via an iterative optimization algorithm. Additionally or alternatively, the term “converge” or “convergence” at least in some examples refers to the output of a function or algorithm getting closer to a specific value over multiple iterations of the function or algorithm.

The term “convolution” at least in some examples refers to a convolutional operation or a convolutional layer of a CNN.

The term “convolutional filter” at least in some examples refers to a matrix having the same rank as an input matrix, but a smaller shape. In machine learning, a convolutional filter is mixed with an input matrix in order to train weights.

The term “convolutional layer” at least in some examples refers to a layer of a DNN in which a convolutional filter passes along an input matrix (e.g., a CNN). Additionally or alternatively, the term “convolutional layer” at least in some examples refers to a layer that includes a series of convolutional operations, each acting on a different slice of an input matrix.

The term “convolutional neural network” or “CNN” at least in some examples refers to a neural network including at least one convolutional layer. Additionally or alternatively, the term “convolutional neural network” or “CNN” at least in some examples refers to a DNN designed to process structured arrays of data such as images.

The term “convolutional operation” at least in some examples refers to a mathematical operation on two functions (e.g., and) that produces a third function ( ) that expresses how the shape of one is modified by the other where the term “convolution” may refer to both the result function and to the process of computing it. Additionally or alternatively, term “convolutional” at least in some examples refers to the integral of the product of the two functions after one is reversed and shifted, where the integral is evaluated for all values of shift, producing the convolution function. Additionally or alternatively, term “convolutional” at least in some examples refers to a two-step mathematical operation includes element-wise multiplication of the convolutional filter and a slice of an input matrix (the slice of the input matrix has the same rank and size as the convolutional filter); and (2) summation of all the values in the resulting product matrix.

The term “covariance” at least in some examples refers to a measure of the joint variability of two random variables, wherein the covariance is positive if the greater values of one variable mainly correspond with the greater values of the other variable (and the same holds for the lesser values such that the variables tend to show similar behavior), and the covariance is negative when the greater values of one variable mainly correspond to the lesser values of the other.

The term “ensemble averaging” at least in some examples refers to the process of creating multiple models and combining them to produce a desired output, as opposed to creating just one model.

The term “ensemble learning” or “ensemble method” at least in some examples refers to using multiple learning algorithms to obtain better predictive performance than could be obtained from any of the constituent learning algorithms alone.

The term “epoch” at least in some examples refers to one cycle through a full training dataset. Additionally or alternatively, the term “epoch” at least in some examples refers to a full training pass over an entire training dataset such that each training example has been seen once; here, an epoch represents N/batch size training iterations, where N is the total number of examples.

The term “event”, in probability theory, at least in some examples refers to a set of outcomes of an experiment (e.g., a subset of a sample space) to which a probability is assigned. Additionally or alternatively, the term “event” at least in some examples refers to a software message indicating that something has happened. Additionally or alternatively, the term “event” at least in some examples refers to an object in time, or an instantiation of a property in an object. Additionally or alternatively, the term “event” at least in some examples refers to a point in space at an instant in time (e.g., a location in spacetime). Additionally or alternatively, the term “event” at least in some examples refers to a notable occurrence at a particular point in time.

The term “experiment” in probability theory, at least in some examples refers to any procedure that can be repeated and has a well-defined set of outcomes, known as a sample space.

The term “F score” or “F measure” at least in some examples refers to a measure of a test's accuracy that may be calculated from the precision and recall of a test or model. The term “F1 score” at least in some examples refers to the harmonic mean of the precision and recall, and the term “Fβ score” at least in some examples refers to an F-score having additional weights that emphasize or value one of precision or recall more than the other.

The term “feature” at least in some examples refers to an individual measureable property, quantifiable property, or characteristic of a phenomenon being observed. Additionally or alternatively, the term “feature” at least in some examples refers to an input variable used in making predictions. At least in some examples, features may be represented using numbers/numerals (e.g., integers), strings, variables, ordinals, real-values, categories, and/or the like.

The term “feature engineering” at least in some examples refers to a process of determining which features might be useful in training an ML model, and then converting raw data into the determined features. Feature engineering is sometimes referred to as “feature extraction.” The term “feature extraction” at least in some examples refers to a process of dimensionality reduction by which an initial set of raw data is reduced to more manageable groups for processing. Additionally or alternatively, the term “feature extraction” at least in some examples refers to retrieving intermediate feature representations calculated by an unsupervised model or a pretrained model for use in another model as an input. Feature extraction is sometimes used as a synonym of “feature engineering.”

The term “feature map” at least in some examples refers to a function that takes feature vectors (or feature tensors) in one space and transforms them into feature vectors (or feature tensors) in another space. Additionally or alternatively, the term “feature map” at least in some examples refers to a function that maps a data vector (or tensor) to feature space. Additionally or alternatively, the term “feature map” at least in some examples refers to a function that applies the output of one filter applied to a previous layer. In some embodiments, the term “feature map” may also be referred to as an “activation map”.

The term “feature vector” at least in some examples, in the context of ML, refers to a set of features and/or a list of feature values representing an example passed into a model. Additionally or alternatively, the term “feature vector” at least in some examples, in the context of ML, refers to a vector that includes a tuple of one or more features.

The term “forward propagation” or “forward pass” at least in some examples, in the context of ML, refers to the calculation and storage of intermediate variables (including outputs) for a neural network in order from the input layer to the output layer.

The term “hidden layer”, in the context of ML and NNs, at least in some examples refers to an internal layer of neurons in an ANN that is not dedicated to input or output. The term “hidden unit”refers to a neuron in a hidden layer in an ANN.

The term “hyperparameter” at least in some examples refers to characteristics, properties, and/or parameters for an ML process that cannot be learnt during a training process. Hyperparameter are usually set before training takes place, and may be used in processes to help estimate model parameters. Examples of hyperparameters include model size (e.g., in terms of memory space, bytes, number of layers, and the like); training data shuffling (e.g., whether to do so and by how much); number of evaluation instances, iterations, epochs (e.g., a number of iterations or passes over the training data), or episodes; number of passes over training data; regularization; learning rate (e.g., the speed at which the algorithm reaches (converges to) optimal weights); learning rate decay (or weight decay); momentum; number of hidden layers; size of individual hidden layers; weight initialization scheme; dropout and gradient clipping thresholds; the C value and sigma value for SVMs; the k in k-nearest neighbors; number of branches in a decision tree; number of clusters in a clustering algorithm; vector size; word vector size for NLP and NLU; and/or the like.

The term “inference engine” at least in some examples refers to a component of a computing system that applies logical rules to a knowledge base to deduce new information.

The terms “instance-based learning” or “memory-based learning” in the context of ML at least in some examples refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), and the like), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest and the like.

The term “intelligent agent” at least in some examples refers to a software agent or other autonomous entity which acts, directing its activity towards achieving goals upon an environment using observation through sensors and consequent actuators (e.g. it is intelligent). Intelligent agents may also learn or use knowledge to achieve their goals.

The term “iteration” at least in some examples refers to the repetition of a process in order to generate a sequence of outcomes, wherein each repetition of the process is a single iteration, and the outcome of each iteration is the starting point of the next iteration. Additionally or alternatively, the term “iteration” at least in some examples refers to a single update of a model's weights during training.

The term “Kullback-Leibler divergence” at least in some examples refers to a measure of how one probability distribution is different from a reference probability distribution. The “Kullback-Leibler divergence” may be a useful distance measure for continuous distributions and is often useful when performing direct regression over the space of (discretely sampled) continuous output distributions. The term “Kullback-Leibler divergence” may also be referred to as “relative entropy”.

The term “knowledge base” at least in some examples refers to any technology used to store complex structured and/or unstructured information used by a computing system.

The term “knowledge distillation” in machine learning, at least in some examples refers to the process of transferring knowledge from a large model to a smaller one.

The term “logit” at least in some examples refers to a set of raw predictions (e.g., non-normalized predictions) that a classification model generates, which is ordinarily then passed to a normalization function such as a softmax function for models solving a multi-class classification problem. Additionally or alternatively, the term “logit” at least in some examples refers to a logarithm of a probability. Additionally or alternatively, the term “logit” at least in some examples refers to the output of a logit function. Additionally or alternatively, the term “logit” or “logit function” at least in some examples refers to a quantile function associated with a standard logistic distribution. Additionally or alternatively, the term “logit” at least in some examples refers to the inverse of a standard logistic function. Additionally or alternatively, the term “logit” at least in some examples refers to the element-wise inverse of the sigmoid function. Additionally or alternatively, the term “logit” or “logit function” at least in some examples refers to a function that represents probability values from 0 to 1, and negative infinity to infinity. Additionally or alternatively, the term “logit” or “logit function” at least in some examples refers to a function that takes a probability and produces a real number between negative and positive infinity.

The term “loss function” or “cost function” at least in some examples refers to an event or values of one or more variables onto a real number that represents some “cost” associated with the event. A value calculated by a loss function may be referred to as a “loss” or “error”. Additionally or alternatively, the term “loss function” or “cost function” at least in some examples refers to a function used to determine the error or loss between the output of an algorithm and a target value. Additionally or alternatively, the term “loss function” or “cost function” at least in some examples refers to a function are used in optimization problems with the goal of minimizing a loss or error.

The term “mathematical model” at least in some examples refer to a system of postulates, data, and inferences presented as a mathematical description of an entity or state of affairs including governing equations, assumptions, and constraints. The term “statistical model” at least in some examples refers to a mathematical model that embodies a set of statistical assumptions concerning the generation of sample data and/or similar data from a population; in some examples, a “statistical model”represents a data-generating process.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably.

The term “machine learning algorithm” or “ML algorithm” at least in some examples refers to an application, program, process, algorithm, and/or function that builds or estimates an ML model based on sample data or training data. Additionally or alternatively, the term “machine learning algorithm” or “ML algorithm” at least in some examples refers to a program, process, algorithm, and/or function that learns from experience w.r. t some task(s) and some performance measure(s)/metric(s), and an ML model is an object or data structure created after an ML algorithm is trained with training data. For purposes of the present disclosure, the terms “ML algorithm”, “AI algorithm”, “AI/ML algorithm”, and the like may be used interchangeably. Additionally, although the term “ML algorithm” may refer to different concepts than the term “ML model,” these terms may be used interchangeably for the purposes of the present disclosure.

The term “machine learning application” or “ML application” at least in some examples refers to an application, program, process, algorithm, and/or function that contains some AI/ML model(s) and application-level descriptions. Additionally or alternatively, the term “machine learning application” or “ML application” at least in some examples refers to a complete and deployable application and/or package that includes at least one ML model and/or other data capable of achieving a certain function and/or performing a set of actions or tasks in an operational environment. For purposes of the present disclosure, the terms “ML application”, “AI application”, “AI/ML application”, and the like may be used interchangeably.

The term “machine learning entity” or “ML entity” at least in some examples refers to an entity that is either an ML model or contains an ML model and ML model-related metadata that can be managed as a single composite entity (in some examples, metadata may include, for example, the applicable runtime context for the ML model). For purposes of the present disclosure, the term “AI/ML entity” or “ML entity” at least in some examples refers to an entity that is either an AI/ML model and/or contains an AI/ML model and that can be managed as a single composite entity. Additionally, the term “ML entity training” at least in some examples refers to ML model training associated with an ML entity. Moreover, the term “AI/ML” may be used interchangeably with the terms “AI”and “ML”throughout the present disclosure.

The term “AI decision entity”, “machine learning decision entity”, or “ML decision entity” at least in some examples refers to an entity that applies a non-AI and/or non-ML based logic for making decisions that can be managed as a single composite entity.

The term “machine learning training”, “ML training”, or “MLT” at least in some examples refers to capabilities and associated end-to-end (e2e) processes to enable an ML training function to perform ML entity (or ML model) training (e.g., as defined herein). In some examples, ML training capabilities include interaction with other parties/entities to collect and/or format the data required for ML model training. Additionally or alternatively, “training an ML entity” refers to training one or more ML model(s) associated with an ML entity internally by an MLT function.

The term “machine learning model training” or “ML model training” at least in some examples refers to capabilities of an ML training function to take data, run the data through an ML model, derive associated loss, optimization, and/or objective/goal, and adjust the parameterization of the ML model based on the computed loss, optimization, and/or objective/goal.

The term “ML initial training” at least in some examples refers to ML entity training that generates an initial version of a trained ML entity.

The term “ML re-training” at least in some examples refers to MLT that generates a new version of a trained ML entity using the same type, but different values or distributions, of training data as that used to train the previous version of the ML entity. This new version of the trained ML entity (e.g., the re-trained ML entity) supports the same type of inference as the previous version of the ML entity, e.g., the data type of inference input and data type of inference output remain unchanged between the two versions of the ML entity The term “machine learning training function”, “ML training function”, or “MLT function”at least in some examples refers to a (logical) function with MLT capabilities.

The term “AI/ML inference function” or “ML inference function” at least in some examples refers to a (logical) function (or set of functions) that employs an ML model and/or AI decision entity to conduct inference. Additionally or alternatively, the term “AI/ML inference function” or “ML inference function” at least in some examples refers to an inference framework used to run a compiled model in the inference host. In some examples, an “AI/ML inference function” or “ML inference function” may also be referred to an “model inference engine”, “ML inference engine”, or “inference engine”.

The term “machine learning workflow” or “ML workflow” at least in some examples refers to a process including data collection and preparation, AI/ML model building/generation; ML model training and testing; ML model deployment, ML model execution, ML model validation and/or verification; continuous, periodic and/or asynchronous ML model monitoring; ML model tuning, learning, and/or retraining. In some examples, the ML model monitoring includes self-monitoring or autonomous monitoring). In some examples, the ML model tuning, learning, and/or retraining includes self-tuning (or autonomous tuning), self-learning (or autonomous learning), and/or self-retraining (or autonomous retraining). The term “machine learning lifecycle” or “ML lifecycle” at least in some examples refers to process(es) of planning and/or managing the development, deployment, instantiation, and/or termination of an ML model and/or individual ML model components.

The term “matrix” at least in some examples refers to a rectangular array of numbers, symbols, or expressions, arranged in rows and columns, which may be used to represent an object or a property of such an object.

The terms “model parameter” and/or “parameter” in the context of ML, at least in some examples refer to values, characteristics, and/or properties that are learnt during training. Additionally or alternatively, “model parameter” and/or “parameter” in the context of ML, at least in some examples refer to a configuration variable that is internal to the model and whose value can be estimated from the given data. Model parameters are usually required by a model when making predictions, and their values define the skill of the model on a particular problem. Examples of such model parameters / parameters include weights (e.g., in an ANN); constraints; support vectors in a support vector machine (SVM); coefficients in a linear regression and/or logistic regression; word frequency, sentence length, noun or verb distribution per sentence, the number of specific character n-grams per word, lexical diversity, and the like, for natural language processing (NLP) and/or natural language understanding (NLU); and/or the like.

The term “momentum” at least in some examples refers to an aggregate of gradients in gradient descent. Additionally or alternatively, the term “momentum” at least in some examples refers to a variant of the stochastic gradient descent algorithm where a current gradient is replaced with m (momentum), which is an aggregate of gradients.

The term “objective function” at least in some examples refers to a function to be maximized or minimized for a specific optimization problem. In some cases, an objective function is defined by its decision variables and an objective. The objective is the value, target, or goal to be optimized, such as maximizing profit or minimizing usage of a particular resource. The specific objective function chosen depends on the specific problem to be solved and the objectives to be optimized. Constraints may also be defined to restrict the values the decision variables can assume thereby influencing the objective value (output) that can be achieved. During an optimization process, an objective function's decision variables are often changed or manipulated within the bounds of the constraints to improve the objective function's values. In general, the difficulty in solving an objective function increases as the number of decision variables included in that objective function increases. The term “decision variable” refers to a variable that represents a decision to be made.

The term “optimization” at least in some examples refers to an act, process, or methodology of making something (e.g., a design, system, or decision) as fully perfect, functional, or effective as possible. Optimization usually includes mathematical procedures such as finding the maximum or minimum of a function. The term “optimal” at least in some examples refers to a most desirable or satisfactory end, outcome, or output. The term “optimum” at least in some examples refers to an amount or degree of something that is most favorable to some end. The term “optima” at least in some examples refers to a condition, degree, amount, or compromise that produces a best possible result. Additionally or alternatively, the term “optima” at least in some examples refers to a most favorable or advantageous outcome or result.

The term “probability” at least in some examples refers to a numerical description of how likely an event is to occur and/or how likely it is that a proposition is true. The term “probability distribution” at least in some examples refers to a mathematical function that gives the probabilities of occurrence of different possible outcomes for an experiment or event.

The term “probability distribution” at least in some examples refers to a function that gives the probabilities of occurrence of different possible outcomes for an experiment or event. Additionally or alternatively, the term “probability distribution” at least in some examples refers to a statistical function that describes all possible values and likelihoods that a random variable can take within a given range (e.g., a bound between minimum and maximum possible values). A probability distribution may have one or more factors or attributes such as, for example, a mean or average, mode, support, tail, head, median, variance, standard deviation, quantile, symmetry, skewness, kurtosis, and the like. A probability distribution may be a description of a random phenomenon in terms of a sample space and the probabilities of events (subsets of the sample space). Example probability distributions include discrete distributions (e.g., Bernoulli distribution, discrete uniform, binomial, Dirac measure, Gauss-Kuzmin distribution, geometric, hypergeometric, negative binomial, negative hypergeometric, Poisson, Poisson binomial, Rademacher distribution, Yule-Simon distribution, zeta distribution, Zipf distribution, and the like), continuous distributions (e.g., Bates distribution, beta, continuous uniform, normal distribution, Gaussian distribution, bell curve, joint normal, gamma, chi-squared, non-central chi-squared, exponential, Cauchy, lognormal, logit-normal, F distribution, t distribution, Dirac delta function, Pareto distribution, Lomax distribution, Wishart distribution, Weibull distribution, Gumbel distribution, Irwin-Hall distribution, Gompertz distribution, inverse Gaussian distribution (or Wald distribution), Chernoff's distribution, Laplace distribution, Pólya-Gamma distribution, and the like), and/or joint distributions (e.g., Dirichlet distribution, Ewens's sampling formula, multinomial distribution, multivariate normal distribution, multivariate t-distribution, Wishart distribution, matrix normal distribution, matrix t distribution, and the like).

The term “probability distribution function” at least in some examples refers to an integral of the probability density function.

The term “probability density function” or “PDF” at least in some examples refers to a function whose value at any given sample (or point) in a sample space can be interpreted as providing a relative likelihood that the value of the random variable would be close to that sample. Additionally or alternatively, the term “probability density function” or “PDF” at least in some examples refers to a probability of a random variable falling within a particular range of values. Additionally or alternatively, the term “probability density function” or “PDF” at least in some examples refers to a value at two different samples can be used to infer, in any particular draw of the random variable, how much more likely it is that the random variable would be close to one sample compared to the other sample.

The term “precision” at least in some examples refers to the closeness of the two or more measurements to each other. The term “precision” may also be referred to as “positive predictive value”.

The term “predictive service” at least in some examples refers to a service model which provides reliable performance, but allowing a specified variance in the measured performance criteria.

The terms “regression algorithm” and/or “regression analysis” in the context of ML at least in some examples refers to a set of statistical processes for estimating the relationships between a dependent variable (often referred to as the “outcome variable”) and one or more independent variables (often referred to as “predictors”, “covariates”, or “features”). Examples of regression algorithms/models include logistic regression, linear regression, gradient descent (GD), stochastic GD (SGD), and the like.

The term “reinforcement learning” or “RL” at least in some examples refers to a goal-oriented learning technique based on interaction with an environment. In RL, an agent aims to optimize a long-term objective by interacting with the environment based on a trial and error process. Examples of RL algorithms include Markov decision process, Markov chain, Q-learning, multi-armed bandit learning, temporal difference learning, and deep RL. The term “multi-armed bandit problem”, “K-armed bandit problem”, “N-armed bandit problem”, or “contextual bandit” at least in some examples refers to a problem in which a fixed limited set of resources must be allocated between competing (alternative) choices in a way that maximizes their expected gain, when each choice's properties are only partially known at the time of allocation, and may become better understood as time passes or by allocating resources to the choice. The term “contextual multi-armed bandit problem” or “contextual bandit” at least in some examples refers to a version of multi-armed bandit where, in each iteration, an agent has to choose between arms; before making the choice, the agent sees a d-dimensional feature vector (context vector) associated with a current iteration, the learner uses these context vectors along with the rewards of the arms played in the past to make the choice of the arm to play in the current iteration, and over time the learner's aim is to collect enough information about how the context vectors and rewards relate to each other, so that it can predict the next best arm to play by looking at the feature vectors.

The term “reward function”, in the context of RL, at least in some examples refers to a function that outputs a reward value based on one or more reward variables; the reward value provides feedback for an RL policy so that an RL agent can learn a desirable behavior. The term “reward shaping”, in the context of RL, at least in some examples refers to adjusting or altering a reward function to output a positive reward for desirable behavior and a negative reward for undesirable behavior.

The term “sample space” in probability theory (also referred to as a “sample description space” or “possibility space”) of an experiment or random trial at least in some examples refers to a set of all possible outcomes or results of that experiment.

The term “search space”, in the context of optimization, at least in some examples refers to a domain of a function to be optimized. Additionally or alternatively, the term “search space”, in the context of search algorithms, at least in some examples refers to a feasible region defining a set of all possible solutions. Additionally or alternatively, the term “search space” at least in some examples refers to a subset of all hypotheses that are consistent with the observed training examples. Additionally or alternatively, the term “search space” at least in some examples refers to a version space, which may be developed via machine learning.

The term “self-attention” at least in some examples refers to an attention mechanism relating different positions of a single sequence in order to compute a representation of the sequence. Additionally or alternatively, the term “self-attention” at least in some examples refers to an attention mechanism applied to a single context instead of across multiple contexts wherein queries, keys, and values are extracted from the same context.

The term “softmax” or “softmax function” at least in some examples refers to a generalization of the logistic function to multiple dimensions; the “softmax function” is used in multinomial logistic regression and is often used as the last activation function of a neural network to normalize the output of a network to a probability distribution over predicted output classes.

The term “supervised learning” at least in some examples refers to an ML technique that aims to learn a function or generate an ML model that produces an output given a labeled data set. Supervised learning algorithms build models from a set of data that contains both the inputs and the desired outputs. For example, supervised learning involves learning a function or model that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

The term “tensor” at least in some examples refers to an object or other data structure represented by an array of components that describe functions relevant to coordinates of a space. Additionally or alternatively, the term “tensor” at least in some examples refers to a generalization of vectors and matrices and/or may be understood to be a multidimensional array. Additionally or alternatively, the term “tensor” at least in some examples refers to an array of numbers arranged on a regular grid with a variable number of axes. At least in some examples, a tensor can be defined as a single point, a collection of isolated points, or a continuum of points in which elements of the tensor are functions of position, and the Tensor forms a “tensor field”. At least in some examples, a vector may be considered as a one dimensional (1D) or first order tensor, and a matrix may be considered as a two dimensional (2D) or second order tensor. Tensor notation may be the same or similar as matrix notation with a capital letter representing the tensor and lowercase letters with subscript integers representing scalar values within the tensor.

The term “tuning” or “tune” at least in some examples refers to a process of adjusting model parameters or hyperparameters of an ML model in order to improve its performance. Additionally or alternatively, the term “tuning” or “tune” at least in some examples refers to a optimizing an ML model's model parameters and/or hyperparameters. In some examples, the particular model parameters and/or hyperparameters that are selected for adjustment, and the optimal values for the model parameters and/or hyperparameters vary depending on various aspects of the ML model, the training data, ML application and/or use cases, and/or other parameters, conditions, or criteria.

The term “unsupervised learning” at least in some examples refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning at least in some examples refers to ML algorithms that develop ML models from incomplete training data, where a portion of the sample input does not include labels.

The term “vector” at least in some examples refers to a one-dimensional array data structure. Additionally or alternatively, the term “vector” at least in some examples refers to a tuple of one or more values called scalars.

The terms “sparse vector”, “sparse matrix”, and “sparse array” at least in some examples refer to an input vector, matrix, or array including both non-zero elements and zero elements.

The terms “dense vector”, “dense matrix”, and “dense array” at least in some examples refer to an input vector, matrix, or array including all non-zero elements.

What is claimed:

1. A method for analyzing and providing suggestions for handwritten math characters entered on a device, the method comprising:
receiving, by at least one processor of a device, first handwritten strokes digitally entered on the device by a user;
inputting, by the at least one processor, the first handwritten strokes into a machine learning model configured to distinguish between mathematical characters and other characters;
classifying, by the machine learning model, the first handwritten strokes as first mathematical characters;
causing, by the at least one processor, the device to present, based on the classifying of the first handwritten strokes as first mathematical characters, a selectable indication of the first handwritten strokes;
receiving, by the at least one processor, a first user selection of the selectable indication;
causing, by the at least one processor, the device to present, based on the first user selection, one or more selectable suggestions for second mathematical characters to follow the first mathematical characters;
receiving, by the at least one processor, a second user selection of a first suggestion of the one or more selectable suggestions;
causing, by the at least one processor, the device to present, based on the second user selection and a style of the first handwritten strokes, second handwritten strokes representing the second mathematical characters, wherein the second handwritten strokes are presented using the style.

2. The method of claim 1, wherein the selectable indication is a highlighted version of the first handwritten strokes.

3. The method of claim 1, wherein the first mathematical characters represent a first step in solving a mathematical problem, and wherein the second mathematical characters represent a second step in solving the mathematical problem, wherein the second step is subsequent and consecutive to the first step.

4. The method of claim 3, wherein the second step is based on a mathematical context of the first step.

5. The method of claim 1, wherein the one or more selectable suggestions comprise the first suggestion and at least one additional suggestion different than the first suggestion.

6. The method of claim 1, further comprising:
causing, by the at least one processor, the device to present a mathematical interpretation of the first mathematical characters, wherein the one or more selectable suggestions is based on the mathematical interpretation.

7. The method of claim 6, further comprising:
receiving, by the at least one processor, a user edit to the mathematical interpretation; and
causing, by the at least one processor, the device to update, based on the user edit, presentation of the first handwritten strokes.

8. The method of claim 1, further comprising:
receiving, by the at least one processor, a user edit to the second handwritten strokes; and
causing, by the at least one processor, the device to update, based on the user edit, presentation of the first handwritten strokes.

9. A system for analyzing and providing suggestions for handwritten math characters entered on a device, the system comprising memory coupled to at least one processor, the at least one processor configured to:
receive first handwritten strokes digitally entered on the device by a user;
input the first handwritten strokes into a machine learning model configured to distinguish between mathematical characters and other characters;
classify, using the machine learning model, the first handwritten strokes as first mathematical characters;
cause the device to present, based on the classifying of the first handwritten strokes as first mathematical characters, a selectable indication of the first handwritten strokes;
receive a first user selection of the selectable indication;
cause the device to present, based on the first user selection, one or more selectable suggestions for second mathematical characters to follow the first mathematical characters;
receive a second user selection of a first suggestion of the one or more selectable suggestions;
cause the device to present, based on the second user selection and a style of the first handwritten strokes, second handwritten strokes representing the second mathematical characters, wherein the second handwritten strokes are presented using the style.

10. The system of claim 9, wherein the selectable indication is a highlighted version of the first handwritten strokes.

11. The system of claim 9, wherein the first mathematical characters represent a first step in solving a mathematical problem, and wherein the second mathematical characters represent a second step in solving the mathematical problem, wherein the second step is subsequent and consecutive to the first step.

12. The system of claim 11, wherein the second step is based on a mathematical context of the first step.

13. The system of claim 9, wherein the one or more selectable suggestions comprise the first suggestion and at least one additional suggestion different than the first suggestion.

14. The system of claim 9, wherein the at least one processor is further configured to:
cause the device to present a mathematical interpretation of the first mathematical characters, wherein the one or more selectable suggestions is based on the mathematical interpretation.

15. The system of claim 9, wherein the at least one processor is further configured to:
receive a user edit to the mathematical interpretation; and
cause the device to update, based on the user edit, presentation of the first handwritten strokes.

16. The system of claim 9, wherein the at least one processor is further configured to:
receive a user edit to the second handwritten strokes; and
cause the device to update, based on the user edit, presentation of the first handwritten strokes.

17. A non-transitory computer-readable storage medium comprising instructions to cause at least one processor for analyzing and providing suggestions for handwritten math characters entered on a device, upon execution of the instructions by the at least one processor, to:
receive first handwritten strokes digitally entered on the device by a user;
input the first handwritten strokes into a machine learning model configured to distinguish between mathematical characters and other characters;
classify, using the machine learning model, the first handwritten strokes as first mathematical characters;
cause the device to present, based on the classifying of the first handwritten strokes as first mathematical characters, a selectable indication of the first handwritten strokes;
receive a first user selection of the selectable indication;
cause the device to present, based on the first user selection, one or more selectable suggestions for second mathematical characters to follow the first mathematical characters;
receive a second user selection of a first suggestion of the one or more selectable suggestions;
cause the device to present, based on the second user selection and a style of the first handwritten strokes, second handwritten strokes representing the second mathematical characters, wherein the second handwritten strokes are presented using the style.

18. The non-transitory computer-readable storage medium of claim 17, wherein the selectable indication is a highlighted version of the first handwritten strokes.

19. The non-transitory computer-readable storage medium of claim 17, wherein the first mathematical characters represent a first step in solving a mathematical problem, and wherein the second mathematical characters represent a second step in solving the mathematical problem, wherein the second step is subsequent and consecutive to the first step.

20. The non-transitory computer-readable storage medium of claim 19, wherein the second step is based on a mathematical context of the first step.
